(19) United States
(12) Patent Application Publication
(10) Pub. No.: US 2013/0238350 A1
(43) Pub. Date: Sep. 12, 2013

(54) CAREGIVING MANAGEMENT SYSTEMS, METHODS AND ARTICLE

(71) Applicant: CARETIME ANALYTICS, LLC, Redmond, WA (US)

(72) Inventor: Douglas J. Baynham, Redmond, WA (US)

(73) Assignee: CARETIME ANALYTICS, LLC, Redmond, WA (US)

(21) Appl. No.: 13/789,185

(22) Filed: Mar. 7, 2013

Related U.S. Application Data
(60) Provisional application No. 61/608,525, filed on Mar. 8, 2012.
(60) Provisional application No. 61/727,547, filed on Nov. 16, 2012.

(51) Int. Cl. G06Q 10/10; G06Q 50/22

(52) U.S. Cl. CPC G06Q 10/109; G06Q 50/22
USPC 705/2

(57) ABSTRACT

An integrated caregiving management system may include one or more caregiving management backend or back office computer systems communicatively coupled to one or more handheld caregiving management devices. The handheld caregiving management devices allow caregivers to automatically track elapsed time for specific caregiving tasks logically associated with particular spaces (e.g., apartments, rooms) and/or care recipients. The caregiving management backend or back office computer systems provide for analysis of data, identification of discrepancies, and reporting of same.

### BACKGROUND

1. Field

This disclosure generally relates to management of the provision of care in caregiving facilities, and more particularly to the use of handheld devices in accomplishing such.

2. Description of the Related Art

The caregiving industry (e.g., assisted living, skilled nursing, hospital care, in-home nursing, adult family homes) continues to grow as the “baby boom” generation retires. This has created unprecedented demand for services, placing pressure on the limited infrastructure. Hence, efficient distribution of resources is critical to meeting the demand.

Oftentimes care is reimbursed by a private or government insurer. Such payers often set strict guidelines for how much care will be compensated, and often do so on a task-by-task basis. Whether the payer is an insurer or a private individual, tracking of actual time versus expected time or reimbursable time or actual fees received is important to proper distribution of the limited resources.

The conventional approach appears to employ paper time sheets which are completed by caregivers, typically at the end of their shift. Caregivers often do not fully complete these time sheets, and the information is often inaccurate. Some of this information may, from time to time, be entered into a computing system. There does not appear to be any real systematic attempt to consistently record and analyze data.

Consequently, conventional approaches may be inadequate.

### BRIEF SUMMARY

The systems and methods described herein are purposely designed for the caregiving industry. Time spent on each resident by all staff members may be analyzed for the purpose of comparison of labor time to fees billed, to identify undercharged residents.

The techniques described herein may primarily focus on identifying undercharged residents. The techniques may also focus on detailed task histories, which helps increase care fees, validate care provided, etc. Such may enable an accurate and documented discussion with payers.

Analysis may be apartment or room specific. Focusing on defined spaces rather than residents or spaces may address concerns regarding data management and transmission under the Health Insurance Portability and Accountability Act (HIPPA) requirements.

Caregiving sessions may automatically start with or without automatically reading a space identifier (e.g., apartment identifier), for example by reading a machine-readable symbol or a wireless transponder (e.g., RFID transponder) at least proximally associated with the space.

The systems and methods allow recording of completed tasks. Caregiving tasks may be logically tied to service plans. Required, upcoming and even overdue tasks may be visually highlighted and/or appropriate notifications electronically sent or alerts produced. This may take advantage of a two-way interface with a second party electronic service plan system.

The systems and methods may accumulate time from all caregivers over a period. This allows analyses which are not skewed by too few interactions, generating more accurate data. Notably, caregiving is often provided by multiple staff over 24-hour days, 7 days a week. Thus, accumulation of time over a representative period is highly useful to producing accurate assessment.

Information may be output in a variety of formats, for example to Microsoft Excel® or CSV format, allowing easy manipulation. Information may be output in graphical and/or text forms, allowing for easy communication. This approach may produce immense data sets by apartment, to be compared to service plans to identify where such a service plan inadequately accounts for needed care.

This use of handheld devices makes training simple; and makes the reporting of services less onerous and even enjoyable, both of which increase usage and reliability. Smartphones, tablet computers, PDAs, netbooks and the like may be configured with appropriate software or firmware applications to implement the desired functionality.

A mobile device to track care may be summarized as including a housing sized to be carried by an end user caregiver; at least one reader operable to read identifying information proximally associated with respective ones of a plurality of defined spaces which are in turn logically associated with respective ones of a plurality of care recipients; at least one transceiver operable to provide wireless communications; a touch-sensitive display operable to display information including a number of user-selectable icons as at least part of a user interface on one or more successive screens presented by the touch-sensitive display; at least one nontransitory processor-readable medium that stores data and executable instructions which at least in part define at least part of the user interface; at least one processor communicatively coupled to the at least one reader, the at least one transceiver, the touch-sensitive display, and the at least one nontransitory processor-readable medium to implement as least part of the user interface, the at least one processor configured to: in response to a first user input, cause the at least one reader to acquire a defined space identifier that uniquely identifies a specific defined space to be logically associated with the delivery of care; and in response to a second user input, display a space identification user selectable icon which allows the end user caregiver to uniquely specify a specific defined space to be logically associated with the delivery of care by the end user caregiver.

The at least one processor may be further configured to cause a display of a start scan user selectable icon, and in response to a user selection of the start scan user selectable icon cause the at least one reader to acquire information which uniquely identifies a specific defined space to be logically associated with the delivery of care and start a timer for a current care session. The at least one processor may further be configured to cause display of a plurality of service type user selectable icons, each of the service type user selectable icons which specify a respective type of service provided as part of caregiving, where the second user input is a user selection of one of the service type user selectable icons. The at least one processor may be configured to cause the display of the start scan user selectable icon selection concurrently on a single screen with the display of the plurality of service type user selectable icons. The at least one processor may further be configured to, following the start of the timer for the current care session, cause a display of a task screen including a plurality of task selection user selectable icons which specify a respective one of a plurality of tasks provided as part of caregiving for the current care session. The at least one processor may further be configured to, in response to a user selection of the one of the service type user selectable icons, stop the timer for the current care session and logically associate the respective task with information indicative of at least an elapsed time for the current care session and indicative of the defined space for the current care session. In response to the end user caregiver uniquely specifying the specific defined space to be logically associated with the delivery of care for the current care session, the at least one processor may further be configured to start the timer for a current care session. The at least one processor may further be configured to, following the start of the timer, cause a display of a task screen including a plurality of task selection user selectable icons which specify a respective one of a plurality of tasks provided as part of caregiving for the current care session. The at least one processor may further be configured to, in response to a user selection of the one of the task selection user selectable icons, stop the timer for the current care session and logically associate the respective task with information indicative of at least an elapsed time and indicative of the defined space for the current care session. The at least one processor may be configured to display the space identification user selectable icon as a scrollable set of room numbers. The at least one reader may be a machine-readable symbol reader operable to read machine-readable symbols located proximate an access way to the defined space. The at least one reader may be a machine-readable symbol reader operable to read machine-readable symbols located proximate a doorway of the defined space. The mobile device may be execute a specific application program with a machine-readable symbol reader scanner removably coupled to the housing thereof.

A method of operating a mobile device to track care may be summarized as including at least one reader, at least one transceiver, a touch-sensitive display, at least one nontransitory processor-readable medium that stores data and executable instructions which at least in part define at least part of the user interface, and at least one processor communicatively coupled to the at least one transceiver and the at least one nontransitory processor-readable medium, the method comprising: causing by the at least one processor a displaying of a start scan user selectable icon by the touch-sensitive display; and causing by the at least one processor a displaying of a plurality of service type user selectable icons by the touch sensitive display, each of the service type user selectable icons which specify a respective type of service provided as part of caregiving; in response to a user input by an end user caregiver indicative of a selection of one of the service type user selectable icons, causing by the at least one processor a displaying of a space identification user selectable icon on the touch-sensitive display, selection of the space identification user selectable icon which allows the end user caregiver to uniquely specify a specific defined space to be logically associated with the delivery of care for a current care session.

The method may further include: in response to a user input by the end user caregiver indicative of a selection of the start scan user selectable icon, causing the at least one reader to acquire information which uniquely identifies a specific defined space to be logically associated with the delivery of care and starting a timer for the current care session. Causing the at least one reader to acquire information which uniquely identifies a specific defined space may include causing at least one of a scanning or an imaging at least one machine-readable symbol at least proximate an access way to the defined space by the reader. Causing a displaying of a start scan user selectable icon by the touch-sensitive display and causing a displaying of a plurality of service type user selectable icons by the touch sensitive display may include causing the displaying of the start scan user selectable icon selection concurrently on a single screen presented by the touch-sensitive display with the displaying of the plurality of service type user selectable icons. The method may further include: following the starting of the timer for the current care session, causing a displaying of a task screen by the touch-sensitive display, the task screen including a plurality of task selection user selectable icons which specify a respective one of a plurality of tasks provided as part of caregiving for the current care session. The method may further include: receiving a user input indicative of a selection of the one of the task selection user selectable icons; and in response to the received user input indicative of the selection of one of the task selection user selectable icons, stopping the timer for the current care session and logically associating the respective selected task for the current care session with information indicative of at least an elapsed time for the current care session and indicative of the defined space for the current care session. The method may further include: receiving a user input uniquely specifying the specific defined space to be logically associated with the delivery of care by the end user caregiver for the current care session; and in response to the received user input uniquely specifying the specific defined space to be logically associated with the delivery of care, starting a timer for the current care session. The method may further include: following the starting of the timer for the current care session, causing a display of a task screen including a plurality of task selection user selectable icons which specify a respective one of a plurality of tasks provided as part of caregiving. The method may further include receiving a user input indicative of a selection of the one of the task selection user selectable icons for the current care session; in response to the received user input indicative of the selection of one of the task selection user selectable icons, stopping the timer for the current care session and logically associating the respective selected task for the current care session with information indicative of at least an elapsed time for the current care session and indicative of the defined space for the current care session. The method may further include: receiving a user input indicative of an identity of the end user caregiver providing care for the current care session; receiving a user input indicative of a selection of the one of the task selection user selectable icons for the current care session; in response to the received user input indicative of the selection of one of the task selection user selectable icons, stopping the timer for the current care session and logically associating the respective selected task for the current care session with information indicative of at least an elapsed time for the current care session, indicative of the defined space for the current care session, and indicative of the identity of the caregiver providing care for the current care session. Causing a displaying of a space identification user selectable icon on the touch-sensitive display may include causing the displaying of the space identification user selectable icon as a scrollable set of room numbers.

A method of operating a caregiving tracking system may be summarized as including receiving information by the caregiving tracking system for each of a plurality of tasks performed by each of a number of caregivers, the information specifying for each of the tasks a defined space identifier associated with where the respective task was performed, and at least one value indicative of a date on which the respective task was performed and indicative at least of an elapsed time during which the respective task was performed; from time to time, analyzing the information; and identifying any of the performed tasks having defined criteria which are outside of a defined threshold of a defined value.

The method may further include automatically electronically transmitting a notification for any defined task having defined criteria which are outside of a defined threshold of a defined value. Identifying any of the performed tasks having defined criteria which are outside of a defined threshold of a defined value may include identifying any defined tasks for which an elapsed time exceeds a defined expected time by more than a defined amount. Identifying any of the performed tasks having defined criteria which are outside of a defined threshold of a defined value may include identifying any defined tasks for which an elapsed time exceeds at least one of an average or a median elapsed time for the respective task over a population of care recipients. Identifying any of the performed tasks having defined criteria which are outside of a defined threshold of a defined value may include identifying any defined tasks that are inconsistent with a list of expected tasks for a selected service. Identifying any of the performed tasks having defined criteria which are outside of a defined threshold of a defined value may include identifying any defined tasks that are inconsistent with a list of expected tasks for a respective defined space. Identifying any of the performed tasks having defined criteria which are outside of a defined threshold of a defined value may include identifying any defined tasks that are inconsistent with a list of expected tasks for a care recipient logically associated with a respective defined space. The method may further include generating a graphical representation of a respective elapsed time for each occurrence of selected task. The method may further include visually emphasizing in the graphical representation any tasks having defined criteria which are outside of a defined threshold of a defined value. The method may further include generating a graphical representation of a respective elapsed time for each occurrence of a selected task as performed by a selected end user caregiver. The method may further include generating a graphical representation of a respective elapsed time for each occurrence of a selected task as performed by a population of end user caregivers. The information may further specify for each of the tasks an identifier indicative of an end user caregiver that performed the respective task.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a partial environmental view of a care facility with a caregiver operating a handheld device, according to one illustrated embodiment.

FIG. 2 is a schematic view of the handheld device with a detachable reader module coupled thereto, according to one illustrated embodiment.

FIG. 3 is a screen print of a login screen displayed on a touch-sensitive display of the handheld device, according to one illustrated embodiment.

FIG. 4 is a screen print of a main navigation screen displayed on a touch-sensitive display of the handheld device, according to one illustrated embodiment.

FIG. 5 is a screen print of a space identifier entry screen displayed on a touch-sensitive display of the handheld device, according to one illustrated embodiment.

FIG. 6 is a screen print of a task selection screen displayed on a touch-sensitive display of the handheld device, according to one illustrated embodiment.

FIG. 7 is a plot or graph of costs or fees versus elapsed time per space or care recipient, according to one illustrated embodiment.

FIG. 8 is a plot or graph of costs or fees versus elapsed time per task, according to one illustrated embodiment.

FIG. 9 is a flow diagram of a high level method of operating a processing system, according to one illustrated embodiment.

FIG. 10 is a flow diagram of a method of operating a backend or back office computing system to analyze information, according to one illustrated embodiment.

FIG. 11 is a flow diagram of a method of operating a backend or back office computing system to analyze information, according to one illustrated embodiment.

### DETAILED DESCRIPTION OF THE INVENTION

In the following description, certain specific details are set forth in order to provide a thorough understanding of various embodiments of the invention. However, one skilled in the art will understand that the invention may be practiced without these details.

Unless the context requires otherwise, throughout the specification and claims which follow, the word “comprise” and variations thereof, such as “comprises” and “comprising”, are to be construed in an open, inclusive sense, that is as “including, but not limited to.”

The headings provided herein are for convenience only and do not interpret the scope of meaning of the claimed invention.

The term “processor-based system” is used herein to denominate systems that include a processor such as a microprocessor, microcontroller, digital signal processors (DSPs), application specific integrated circuit (ASIC), programmed logic controller (PCL), programmable gate array (PGA) for instance a field programmable gate array (FPGA) or other controllers.

### Overview of Processing System

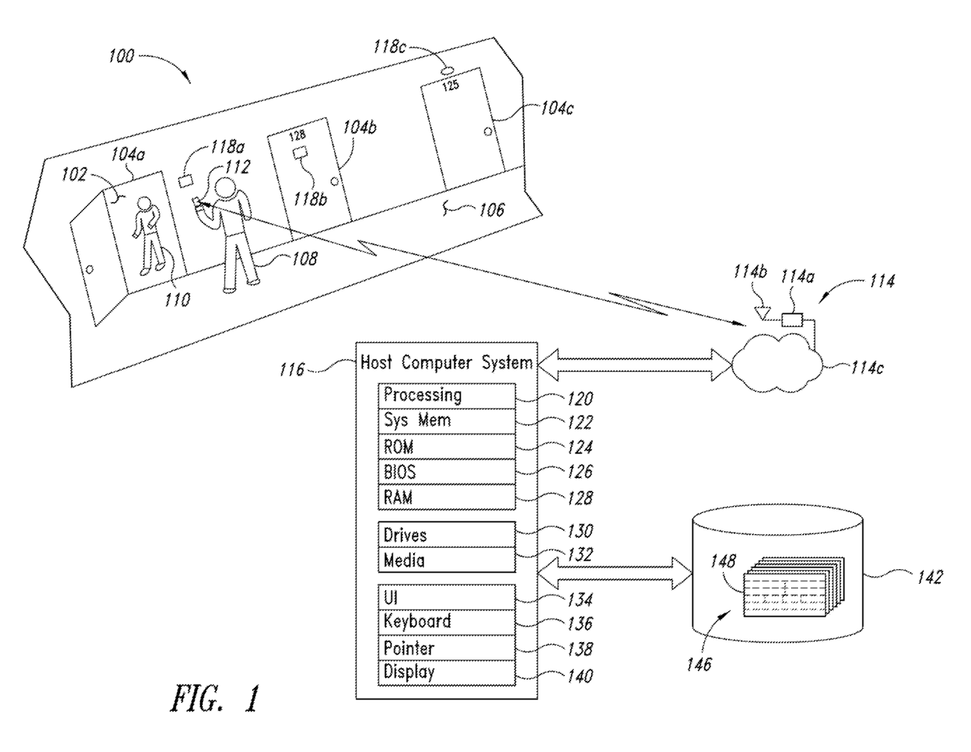

FIG. 1 shows a portion of a caregiving facility 100, according to one illustrated embodiment.

The caregiving facility 100 includes a number of defined spaces 102 (only one shown), which may be denominated as apartments or rooms, as appropriate to the particular caregiving facility 100. Each space 102 has an associated access way 104a-104c (three shown, collectively 104), for example a door, which provides access into and from the defined space 102. The access ways 104 may for example lead to a corridor 106 or some other space. While not illustrated, the caregiving facility 100 may have a variety of other spaces, for example break rooms, day rooms, game rooms, cafeterias, dining rooms, exercise rooms, therapy rooms, etc.

As illustrated in FIG. 1, a caregiver 108 may arrive at an access way 104 of one of the defined spaces (e.g., apartment or room) 102 in order to provide care to a care recipient 110, for instance a resident or patient who resides in or is otherwise assigned to the particular defined space 102.

The caregiver 108 may carry a handheld caregiving management device 112. One or more handheld caregiving management devices 112 (only one illustrated) are communicatively coupled via one or more communications channels 114 with one or more caregiving management backend or back office computer systems 116 to form an integrated caregiving management system, as described herein. The communications channels 114 may include one or more transceivers 114a and associated antenna 114b to provide wireless communications with the handheld caregiving management devices 112. The transceivers 114a and associated antenna 114b may, for example take the form of a wireless “hotspot” using conventional wireless communications protocols, for example IEEE 802.11 protocol. The communications channels 114 may include one or more wired or wireless channels, for example a network 114c, for instance a local area network (LAN) and/or wide area network (WAN), which couples the transceivers to the caregiving management backend or back office computer system 116.

The caregiver 108 uses the handheld caregiving management device 112 to collect and record information about care provided by the caregiver 108 to the care recipient 110. Such may be collected and recorded in terms of discrete caregiving sessions, which may include performance of one or more caregiving tasks.

In some situations, the caregiver 108 may use the handheld caregiving management device 112 to automatically read a data carrier at least proximally associated with the particular space and/or care recipient. For example, the caregiver 108 may use the handheld caregiving management device 112 to read information encoded in a machine-readable symbol 118a, 118b (two shown, collectively) posted proximate respective access ways 104a, 104b. Also for example, the caregiver 108 may use the handheld caregiving management device 112 to read information encoded in a wireless transponder, for instance a radio frequency identification (RFID) transponder 118c (only one shown) posted proximate a respective access way 104c.

For example, the access way 104 may have inscribed on, include, carry or bear a machine-readable symbol 118a, 118b at least proximate to an access way 104. The machine-readable symbol 104a, 104b may take any of a variety of forms, for instance a one-dimensional machine-readable symbol (i.e., barcode symbol) or two-dimensional machine-readable symbol (e.g., area or matrix code symbol) which encodes a unique identifier (e.g., apartment or room identifier) and is readable by a machine-readable symbol reader or subsystem of the handheld caregiving management device 112. The machine-readable symbol 118a, 118b may, for example, be printed on a label and adhered to or proximate the access way 104, for instance on an appropriate surface thereof.

Also for example, the access way 104 may carry or bear a wireless transponder 118c such as a passive radio frequency identification (RFID) transponder or tag which encodes a unique identifier and/or other information that is readable and/or writeable by a reader (e.g., interrogator) of the handheld caregiving management device 112. The wireless transponder 118c may, for example, be formed as a printed circuit trace antenna and integrated circuit component on a tag and adhered to an appropriate surface at least proximate the access way 104.

As another example, a combination machine-readable symbol and RFID transponder or tag (not shown) may be employed, which encodes a unique identifier and/or other information that is readable by a reader or interrogator and/or writeable thereby. In each of the above examples, use of a wireless transponder may provide advantages over machine-readable symbols, for example allowing storage of information, data or conditions after the transponder or tag is applied to the component. Such may also provide for non-line-of-sight reading. Various examples of operation advantageously employing wireless transponders and/or machine-readable symbols are described herein.

The caregiving management backend or back office computer system 116 may take the form of a conventional mainframe computer, mini-computer, workstation computer, personal computer (desktop or laptop), or handheld computer. The caregiving management backend or back office computer system 116 may include a processing unit 120, a system memory 122 and a system bus (not shown) that couples various system components including the system memory 122 to the processing unit 120. The caregiving management backend or back office computer system 116 will at times be referred to in the singular herein, but this is not intended to limit the embodiments to a single caregiving management backend or back office computer system 116, since in typical embodiments there may be more than one caregiving management backend or back office computer system 116 or other device involved. Non-limiting examples of commercially available computer systems include, but are not limited to, an 80×86, Pentium, or i7 series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 120 may be any logic processing unit, such as one or more central processing units (CPUs), digital signal processing units (DSPs), application-specific integrated circuits (ASICs), programmable gate arrays (PGAs) programmed control units (PLUs), etc. Unless described otherwise, the construction and operation of the various blocks shown in FIG. 1 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 122 includes read-only memory (“ROM”) 124 and random access memory (“RAM”) 128. A basic input/output system (“BIOS”) 471, which can form part of the ROM 124, contains basic routines that help transfer information between elements within the caregiving management backend or back office computer system 116, such as during start-up.

The caregiving management backend or back office computer system 116 may also include one or more media drives 130 (e.g., a hard disk drive, magnetic disk drive, and/or optical disk drive) for reading from and writing to computer-readable storage media 132 (e.g., hard disk, optical disks, and/or magnetic disks). The computer-readable storage media 132 may, for example, take the form of removable media. For example, hard disks may take the form of Winchester drives, optical disks can take the form of CD-ROMs, while magnetic disks can take the form of magnetic floppy disks or diskettes. The media drive(s) 130 communicate with the processing unit 120 via one or more system buses. The media drives 130 may include interfaces or controllers (not shown) coupled between such drives and the system bus, as is known by those skilled in the relevant art. The media drives 130, and their associated computer-readable storage media 132, provide nonvolatile storage of computer readable instructions, data structures, program engines and other data. Although described as employing computer-readable storage media 132 such as hard disks, optical disks and magnetic disks, those skilled in the relevant art will appreciate that caregiving management backend or back office computer system 116 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, data collected from operation of handheld caregiving management device(s) 112 related to provision of care, can be stored in the computer-readable storage media 132. The data related to provided care may include data that is indicative of space or care recipient identity, caregiving task performed, date, start time, end time, and or elapsed time of caregiving session, and/or identity of caregiver.

Program engines, such as an operating system, one or more application programs, other programs or engines and program data, can be stored in the system memory 122. Program engines may include instructions to store and/or retrieve information regarding the providing of care, and particularly information related to each caregiving session, the caregiving tasks performed and the time required to adequately perform those caregiving tasks. For example, a program engine may store and/or retrieve collected data representing the operation of the handheld caregiving management device(s) 112, the characteristics of a caregiving session to the nontransitory storage media 142. Such may, for example, be stored in and/or retrieved from one or more data structures 144, for example data structures of a relational database 146. Such may, for example, be broken out by defined space and/or care recipient, by caregiving task, caregiver, and/or by facility.

Program engines may include instructions for analyzing the caregiving related data. For example, the instructions may cause comparison of billed costs or fees versus actual costs or fees or time actually spent on providing care. Such may be analyzed on a space-by-space or care recipient basis. Such may be done on a caregiver-by-caregiver basis. Such may be done on a facility-by-facility basis. The instructions may cause the production of one or more graphs illustrating the analysis. The instructions may cause the identification of discrepancies from expected values, and particularly identification of discrepancies that are outside of a threshold or range of an expected value. The instructions may cause electronic transmission of a notification when a discrepancy occurs and/or produce a notification or alert, for instance a visual emphasis in a graph. Additional details regarding the various operations are discussed herein with respect to the various methods of operation.

Program engines may include instructions for handling security such as password or other access protection and communications encryption. The system memory 122 may also include communications programs, for example, a Web client or browser that permits the caregiving management backend or back office computer system 116 to access and exchange data with sources such as Web sites of the Internet, corporate intranets, extranets, or other networks as described below, as well as other server applications on server computing systems such as those discussed further below. The browser may, for example, be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 122, the operating system, application programs, other programs/engines, program data and/or browser can be stored on the computer-readable storage media 132 of the media drive(s) 130.

An operator can enter commands and information via a user interface 134 through input devices such as a touch screen or keyboard 136 and/or a pointing device 138 such as a mouse. Other input devices can include a microphone, joystick, game pad, tablet, scanner, etc. These and other input devices are connected to the processing unit 120 through an interface such as a serial port interface that couples to the system bus, although other interfaces such as a parallel port, a game port or a wireless interface or a universal serial bus (“USB”) can be used. A display or monitor 140 may be coupled to the system bus via a video interface, such as a video adapter. The caregiving management backend or back office computer system 116 can include other output devices, such as speakers, printers, etc.

The caregiving management backend or back office computer system 116 may be communicatively coupled to one or more handheld caregiving management device 112, for example via a dedicated communications channel such as a set of wires or wire bundle, employing serial or parallel communications, or via a shared, network communications channel. The caregiving management backend or back office computer system 116 can operate in a networked environment using logical connections to one or more remote computers and/or devices. For example, the caregiving management backend or back office computer system 116 can operate in a networked environment using logical connections to one or more handheld caregiving management device 112. Communications may be via a wired and/or wireless network architecture, for instance, wired and wireless enterprise-wide computer networks, intranets, extranets, and the Internet. Other embodiments may include other types of communication networks including telecommunications networks, cellular networks, paging networks, and other mobile networks.

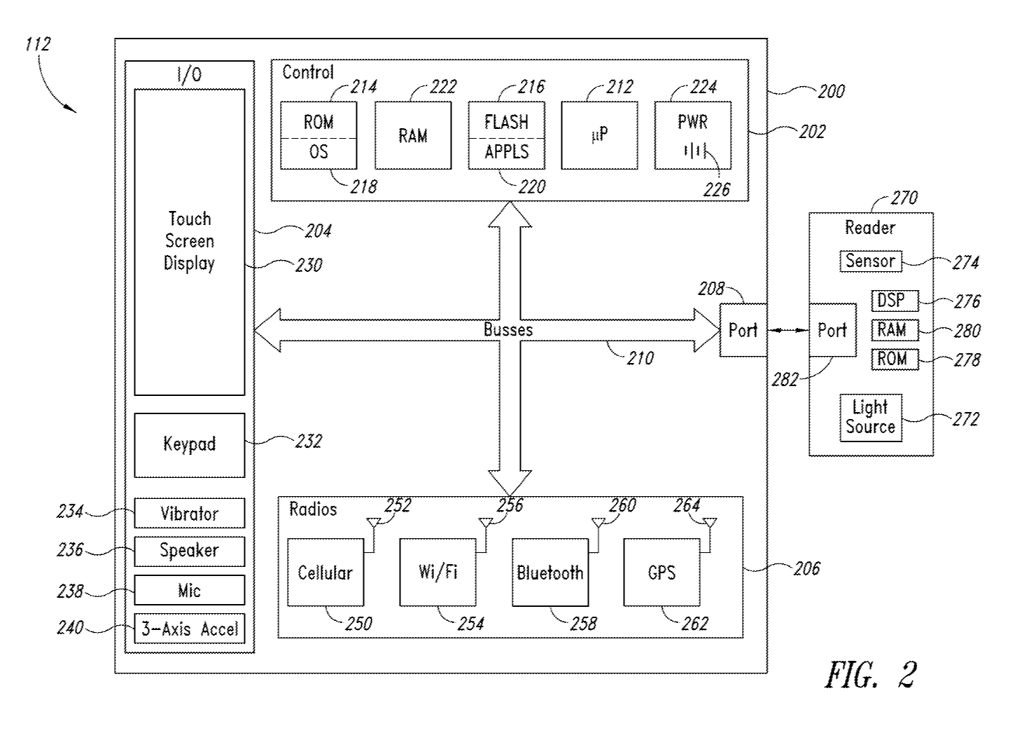

FIG. 2 shows a handheld caregiving management device 112, according to one illustrated embodiment.

The handheld caregiving management device 112 may, for example, take the form of a dedicated device, or may take the form of a Smartphone, personal digital assistant (PDA), tablet computer system, netbook computer system, laptop computer system, handheld communications device or the like running one or more caregiving management applications.

The handheld caregiving management device 112 has a housing 200, which is preferably configured to be portable, and handheld when in use. The handheld caregiving management device 112 may include a number of subsystems housed by the housing. For example, the handheld caregiving management device 112 may include a control subsystem 202, an input/output (I/O) subsystem 204, a wireless communications subsystem 206, and may include one or more communications ports 208 (only one shown) to provide wired communications therefrom. The various subsystems 202, 204, 206 and communications ports 208, and/or components thereof are powered and/or communicatively coupled via one or more buses 210 (only one shown) or other structures. The buses may, for example, include one or more power, communications, data, instructions, and/or address buses.

The control subsystem 202 may take any of a large variety of forms. Without limiting the alternatives, the control subsystem 202 may include one or more controllers 212, for example one or more microprocessors (e.g., ARM based CPU), digital signal processors (DSPs), application specific integrated circuits (ASICs), programmable gate arrays (PGAs), programmed logic controllers (PLCs), etc. programmed or otherwise configured to control operation of the handheld caregiving management device 112. The controller 212 may be communicatively coupled to one or more nontransitory processor readable media. For example, the controller 212 may be coupled to nonvolatile memory which stores instructions and/or data, for instance read only memory (ROM) 214 or Flash memory 216. The ROM may store processor executable instructions, for instance an operating system 218. The Flash memory 216 may store processor executable instructions, for example one or more caregiving management applications 220. Additionally, or alternatively, the controller 212 may be coupled to volatile memory which stores instructions and/or data, for instance random access memory (RAM) 222.

The control subsystem 202 may include a power supply subsystem 224. The power supply subsystem may include circuitry (not shown) and other components for conditioning power, for instance step up converters, step down converters, rectifiers, filters, etc. The power supply subsystem may include an on-board power source 226 (e.g., secondary chemical battery, fuel cell, ultra-capacitor array).

The I/O subsystem 204 may, for example, include one or more displays, such as a touch-sensitive display (e.g., LCD touch panel) 230. The touch sensitive display 230 may display user selectable icons, for example including virtual keys of a virtual keyboard or keypad (not shown). The I/O subsystem 204 may optionally include a physical keyboard or keypad 232 having physical keys. The I/O subsystem 204 may include one or more speakers 234 to provide sounds such as alerts and or spoken prompts. The I/O subsystem 204 may include one or more microphones 236, for example to allow entry of spoken voice commands. The I/O subsystem 204 may include one or more vibrators 238 (e.g., piezoelectric vibration elements) to provide tactile alerts or feedback to the end user. The I/O 204 may include an accelerometer, for example a three-axis accelerometer 240 allowing detection of acceleration, movement, or gravitational force.

The wireless communications subsystem 206 may include one or more transmitters, receivers or transceivers, collectively referred to herein as radios, and associated antennas. The radios and antennas may be operable to communicate over a large variety of frequencies (e.g., radio or microwave frequencies), using a large variety of communications protocols (e.g., CDMA, TDMA, GSM).

For example, the wireless communications subsystem 206 may include one or more cellular radios 250 and associated antennas 252 configured to communicate via a cellular communications of a cellular service provider. Such communications may include data, voice, SMS, etc., employing any protocol supported by the particular cellular service provider network. Also for example, the wireless communications subsystem 206 may include one or more radios 254 and associated antennas 256 configured to communicate via Wi-Fi® or similar IEEE 802.11 compliant wireless network infrastructure. Also for example, the wireless communications subsystem 206 may include one or more radios 258 and associated antennas 260 configured to communicate via Bluetooth® compliant wireless infrastructure.

The wireless communications subsystem 206 may include one or more Global Positioning System (GPS) receivers 262 or similar such receivers and associated antenna(s) 264. The GPS receiver 262 receives signals from GPS satellites (not shown), allowing determination of a position of the handheld caregiving management device 112 in a global coordinate frame (e.g., longitude, latitude). Various spatial location determination units (e.g., GPS) are commercially available in a variety of form factors, including those suitable for inclusion in handheld devices.

The communications port(s) 208 may provide communications with external devices and systems. The communications ports 208 may include wired as well as wireless ports. For example, the communications ports 208 may include Ethernet ports, Universal Serial Bus (USB) ports, Firewire ports, Thunderbolt ports, etc., and/or ports compliant with various IEEE 802.11 protocols.

The handheld caregiving management device 112 includes a reader 270, which may be integral thereto, or removably coupled to the housing 200 of the handheld caregiving management device 112. The reader 270 is operable to read information encoded in one or more data carriers (e.g., machine-readable symbols 118a, 118b, RFID transponders 118c).

The reader 270 may take the form of a machine-readable symbol reader which itself may take any of a large variety of forms, for example laser based or scanning machine-readable symbol readers or flood illumination or imaging based machine-readable symbol readers. Machine-readable symbol reader scanning units are commercially available in a variety of form factors, including those suitable for inclusion in handheld devices. Without limiting the alternatives, the reader 270 is discussed below with respect to a machine-readable symbol reader embodiment. The reader 270 may include one or more illumination sources 272, or may rely on ambient lighting. Suitable illumination sources 272 may include a laser and optionally a scanning mirror (e.g., oscillating mirror or rotating polygonal mirror, neither shown). Suitable illumination sources 272 may include one or more LEDs. The reader 270 may include one or more sensors or detectors 274. Suitable sensors or detectors 274 may, for example, include linear or two-dimensional arrays of charge coupled devices (CODs), photodiodes, Vidicons, and/or CMOS image capture devices. The reader 270 may include one or more controllers 276, for example one or more microprocessors, DSPs, ASICs, PGAs, PLCs, etc., to be programmed or otherwise configured to decode information read from the machine-readable symbols. The controller 276 may be communicatively coupled to one or more nontransitory processor readable media. For example, the controller 276 may be coupled to nonvolatile memory which stores instructions and/or data, for instance ROM or Flash memory 278. Additionally, or alternatively, the controller 276 may be coupled to volatile memory which stores instructions and/or data, for instance RAM 280. Alternatively, the reader 270 may rely on the control subsystem 202 to control operation of the various components of the reader 270, including decoding.

Where implemented as a detachable component, the reader 270 may include one or more ports 282 to provide selectively detachable communicative and/or power coupling to the handheld caregiving management device 112. This allows existing Smartphones, PDAs, computing tablets or netbooks to be easily retrofitted to perform caregiving monitoring.

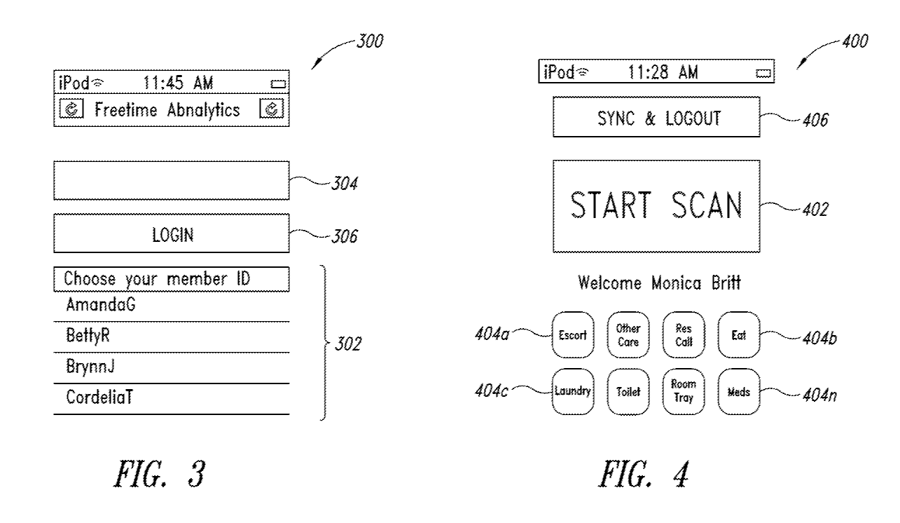

FIG. 3 shows a login screen 300 which can be displayed on the display 230 (FIG. 2) of a handheld caregiving management device 112, according to one illustrated embodiment.

The login screen 300 includes a number of user selectable icons and/or user fillable fields. For example, the login screen 300 may include a list of user selectable care provider identifiers 302, for example names or partial names of the various caregivers who may use the handheld caregiving management device 112. An end user may select the end user's own name from the list 302. The list 302 may be scrollable.

The login screen 300 may include a password field 304 into which the end user enters a password. The end user may use a physical keyboard or keypad to enter a password, which may or may not include alphabetic characters, digits, and other symbols. Alternatively, selection of the password field 304 may automatically bring up a virtual keyboard or keypad for the end user to enter the password.

The login screen 300 may include a user selectable login icon 306, selection of which submits the selected user identifier and password for verification. Verification may be performed by the handheld caregiving management device 112. Alternatively, selection may cause a message including user identity and password information to be sent to the caregiving management backend or back office computer system 116, which performs the verification and transmits an appropriate message back to the handheld caregiving management device 112.

FIG. 4 shows a main navigation screen 400 which can be displayed on the display 230 (FIG. 2) of a handheld caregiving management device 112, according to one illustrated embodiment.

The main navigation screen 400 includes a number of user selectable icons and/or user fillable fields. For example, the main navigation screen 400 may include a start scan user selectable icon 402. User selection of the start scan user selectable icon 402 causes a reader to try to automatically read space or care recipient identification information. For example, selection of the start scan user selectable icon 402 may cause a processor to cause the reader to optically scan or image a machine-readable symbol and attempt to decode information encoded in such, and/or wirelessly interrogate a wireless transponder and attempt to decode information encoded in such.

Also for example, the main navigation screen 400 may include a plurality of service type user selectable icons 404a, 404b, 404c, 404n (eight shown, only four called out, collectively 404). Each of the service type user selectable icons 404 specifies a respective type of service which may be provided as part of caregiving. Types of service may, for example, include: escort, resident call, eat, laundry, toilet, room tray, medications, and other care. This list should not be considered exhaustive. The set of service type user selectable icons 404 may be scrollable where there are too many to fit on a single screen. In response to user selection of one of the service type user selectable icons 404, the processor displays a space identifier screen 500 discussed below with reference to FIG. 5.

The service type user selectable icons 404 may be displayed currently on same screen with start scan user selectable icon 402. Such advantageously automatically implements a bifurcated algorithmic approach to account for two distinctly different situations in the caregiving environment, explained in more detail below.

The main navigation screen 400 may also include a synchronize and logout user selectable icon 406. In response to user selection of the synchronize and logout user selectable icon 406, the processor may synchronize information for a current caregiving session and may log the end user caregiver out. Synchronization may, for example, include packaging relevant information in a packet and transmitting such to the caregiving management backend or back office computer system 116. Such may alternatively include saving the relevant information in some data structure in a nontransitory storage medium of the handheld caregiving management device 112. For example, information may be stored until either a wired or wireless connection becomes available.

FIG. 5 shows a space identifier entry screen 500 which can be displayed on the display 230 (FIG. 2) of a handheld caregiving management device 112, according to one illustrated embodiment.

The space identifier entry screen 500 includes a number of user selectable icons and/or user fillable fields. For example, the space identifier entry screen 500 may include a scrollable list of space identifiers 502 (e.g., apartment or room numbers). Such allows the caregiver to select a space or care recipient that is to be logically associated with a current caregiving session. Such may, for instance, be implemented to appear as a wheel or reel which appears to rotate when swiped or otherwise activated by the end user caregiver. Such may allow scrolling in two opposed directions.

Also for example, the space identifier entry screen 500 may include a select apartment user selectable icon 504. Selection of select apartment user selectable icon 504 accepts or submits the currently selected space identifier.

Also for example, the space identifier entry screen 500 may include a cancel user selectable icon 506. User selection of the cancel user selectable icon 506 causes display of the main navigation screen 400 (FIG. 4).

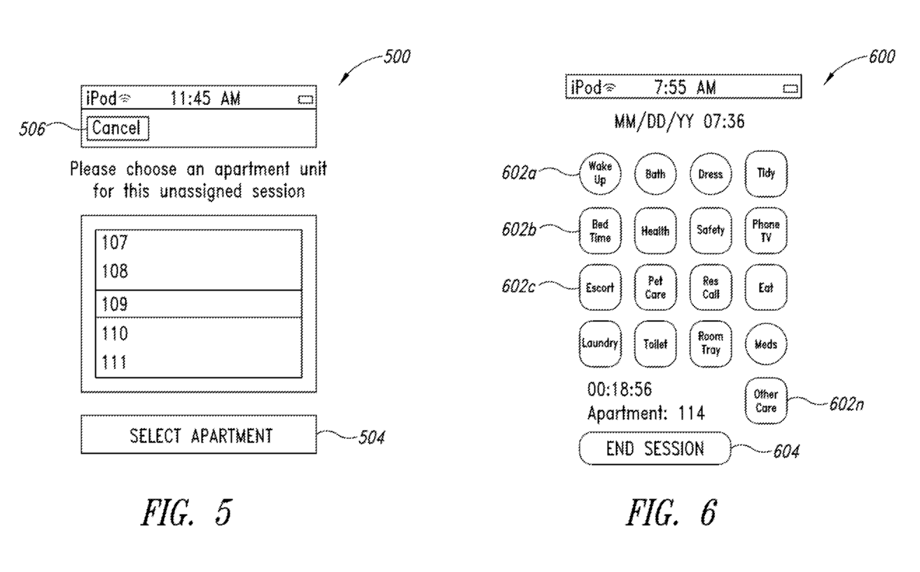

FIG. 6 shows a task entry screen 600 which can be displayed on the display 230 (FIG. 2) of a handheld caregiving management device 112, according to one illustrated embodiment.

The task entry screen 600 includes a number of user selectable icons and/or user fillable fields. For example, the task entry screen 600 includes a plurality of specific task selection user selectable icons 602a, 602b, 602c, 602n (seventeen shown, four called out, collectively 602). Each of the task selection user selectable icons 602 specifies a respective caregiving task which may be provided as part of caregiving. Types of caregiving tasks may, for example, include: wake-up, bath, dress, tidy, bedtime, health related, safety related, phone or television assistance, escort, pet care, residential call, eat, laundry, toilet, room tray, medications, and other care. This list should not be considered exhaustive. The set of task selection user selectable icons 602 may be scrollable where there are too many tasks to fit on a single screen. Selection of one of the task selection user selectable icons 602 causes the associated task to be logically associated with the current caregiving session.

Also for example, the task entry screen 600 includes an end session user selectable icon 604. Selection of the end session user selectable icon 604 may signify an end of a caregiving session, causing tracked or recorded information to be saved or transmitted.

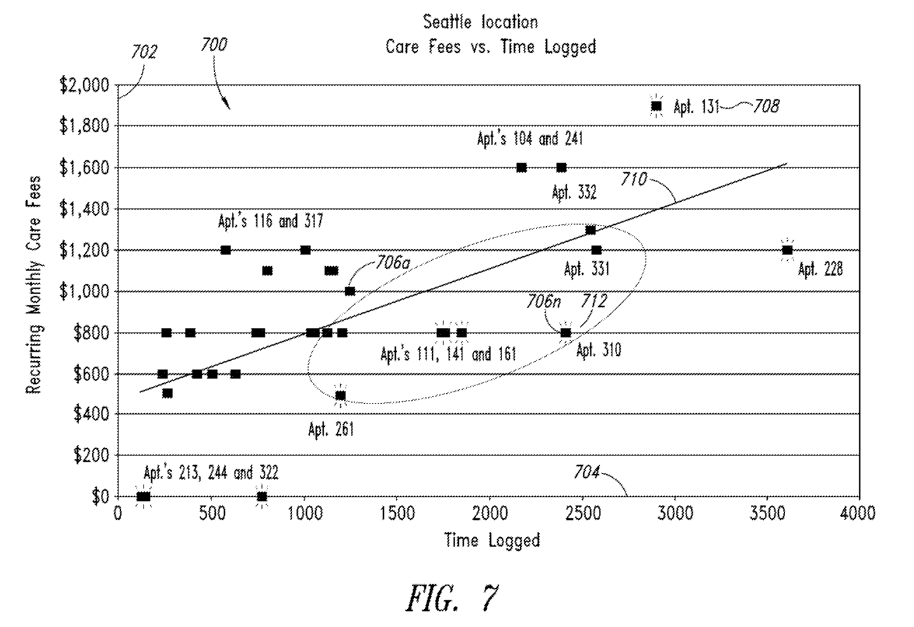

FIG. 7 shows a graphical relationship 700 of care fees versus elapsed time for a plurality of spaces or care recipients, according to one illustrated embodiment. In particular, care fees are represented along the vertical or Y-axis 702 while elapsed time is represented along the horizontal or X-axis 704. This relationship 700 is not intended to necessarily reflect any actual processing or actual collected information, but rather is provided to illustrate the various concepts employed herein.

The relationship 700 may be presented on a display and/or provided on paper as a hard copy. A plurality of data points 706a, 706n (many shown, only two called out, collectively 706) corresponding to respective spaces or care recipients are each illustrated as square blocks. Many of the data points 706 have identifiers 708 (only one called out) proximate thereto, identifying the specific space (e.g., apartment) to which the data point 706 corresponds.

An average or median of actually elapsed time is represented by a straight line 710. Data points which are inconsistent or outside a threshold or range of the median may be visually emphasized 712, for example using a different color, highlighting, flashing or some other visual effect.

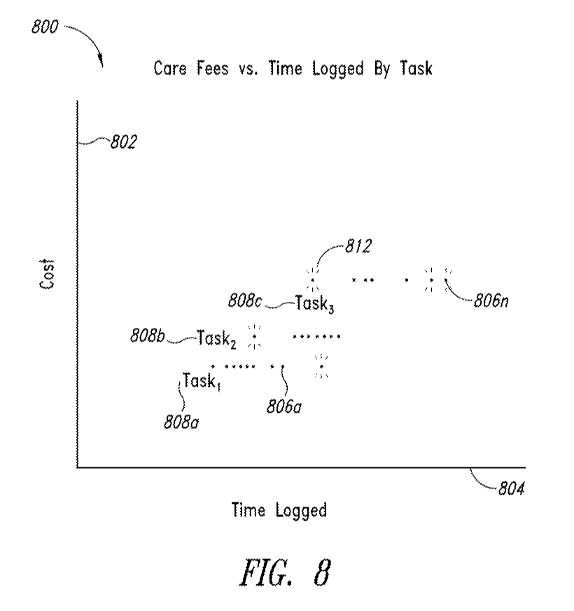

FIG. 8 show a graphical relationship 800 of care fees versus elapsed time for a plurality of caregiving tasks, according to one illustrated embodiment. In particular, care fees are represented along the vertical or Y-axis 802 while elapsed time is represented along the horizontal or X-axis 804. This relationship 800 is not intended to necessarily reflect any actual processing or actual collected information, but rather is provided to illustrate the various concepts employed herein.

The relationship 800 may be presented on a display and/or provided on paper as a hard copy. A plurality of data points 806a, 806n (many shown, only two called out, collectively 806) corresponding to respective spaces or care recipients are each illustrated as square blocks. The data points 806 are grouped by task, and have associated task identifiers 808a, 808b, 808c (three called out, collectively 808) proximate thereto, identifying the specific task (e.g., apartment) to which the data point 806 corresponds.

Data points which are inconsistent or outside a threshold or range of the median may be visually emphasized 812, for example using a different color, highlighting, flashing or some other visual effect.

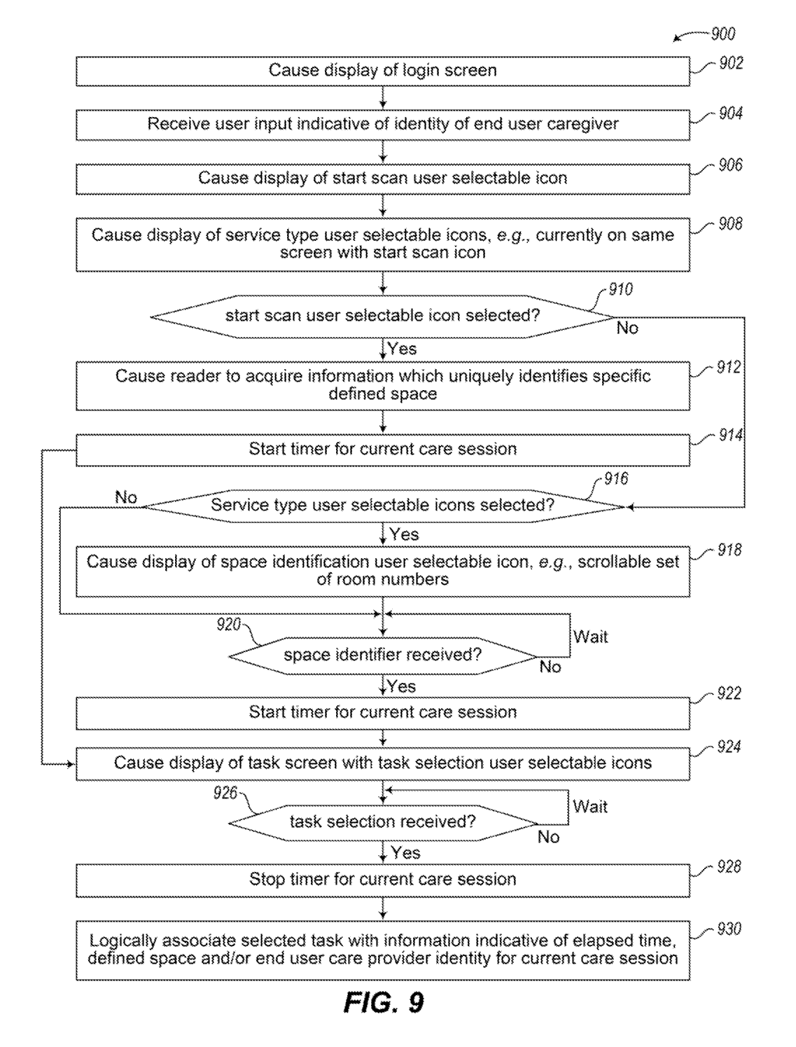

FIG. 9 shows a method 900 of operation of a caregiving management system, according to one illustrated embodiment.

At 902, a processor of an end user caregiver operated handheld caregiving management device causes a display of a login screen on a display thereof, for example on a touch-sensitive display.

At 904, the processor receives user input indicative of an identity of an end user caregiver who will be delivering care to a care recipient during a current caregiving session. For example, the end user caregiver may select the end user's own name from a list of caregiver names. Alternatively, the end user caregiver may select some other identifier from a list of other caregiver identifiers. As a further alternative, the end user caregiver may enter the end user's name or some other identifier, for example via a keyboard or keypad. The keyboard or keypad may, for instance, take the form of either a physical keyboard or keypad or a virtual keyboard or keypad displayed on the touch-sensitive display. Additionally, the processor may require the end user caregiver to enter a password to authenticate or otherwise verify an identity of the end user caregiver.

At 906, the processor causes a display of a start scan user selectable icon. The start scan user selectable icon allows the end user caregiver to trigger a reader of the handheld caregiving management device to read (e.g., scan or image and decode) a machine-readable symbol at least proximately spatially associated with a defined space, for instance a room or apartment.

At 908, the processor causes a display of a plurality of service type user selectable icons. Each of the service type user selectable icons specifies a respective type of service which may be provided as part of the caregiving. The service type user selectable icons may be displayed currently on the same screen with the start scan user selectable icon. Such advantageously automatically implements a bifurcated algorithmic approach to account for two distinctly different situations in the caregiving environment, explained in more detail below.

In one situation, the end user caregiver is proximate a defined space (e.g., room, apartment) logically associated with a particular care recipient. In such a situation, a machine-readable symbol is typically present, which encodes information that uniquely identifies at least one of the defined space and/or the care recipient. For example, the machine-readable symbol may encode a room or apartment number or identifier. The room or apartment number or other identifier may be logically associated, for instance via a data structure, with a particular care recipient (e.g., resident, patient). Such greatly expedites the management process by allowing automatic entry of information which reduces caregiver work load as well as reducing the occurrence of errors.

In the other situation, the end user caregiver may not be proximate the defined space or the machine-readable symbol may otherwise not be available or readable. For instance, a caregiving session may start in a common space, for example a common room, dayroom, break room, cafeteria or dining room, exercise room, entertainment room or visiting room. While not as automated as the first situation, the approach described herein automates the collection of information to the extent possible, again reducing caregiver workload and reducing the occurrence of errors.

At 910, the processor determines whether the end user caregiver has selected the start scan user selectable icon, indicating that a machine-readable symbol is likely present and that the reader should be triggered to read the machine-readable symbol.

In response to selection of the start scan user selectable icon, at 912 the processor causes the reader to acquire information from the machine-readable symbol, if present. The information should uniquely identify a specific defined space. The reader may acquire the information by, for example, scanning the machine-readable symbol, and capturing a scan profile of the machine-readable symbol. For instance, the reader may cause a laser beam produced by one or more laser diodes to scan across the machine-readable symbol and capture the scan profile with one or more photodiodes. Scanning may be accomplished by, for instance, an oscillating reflector or mirror or by a rotating polygonal reflector or mirror. Alternatively, the reader may acquire the information by, for example, flood illuminating the machine-readable symbol, and capturing an image of the illuminated machine-readable symbol. For instance, the reader may cause a number of light sources (e.g., LEDs) to emit light, and capture light returned from the machine-readable symbol with a one- or two-dimensional charge coupled device (CCD) array or a complementary metal oxide semiconductor (CMOS) imager. The reader may decode information encoded in the machine-readable symbol, for example using a digital signal processor to decode information based on any one or more machine-readable symbologies (e.g., UPC/EAN, UNICODE). As used herein and in the claims, the term scanning is used consistently with its vernacular use, that is to apply to both scanning with a point of light or imaging using flood illumination. Whether using the scanning approach or imaging approach, the processor may verify that the decoded information corresponds to a valid space identifier, for example checking a lookup table or some other data structure, or sending a query to an external system.

At 914, in response to the reading of a valid identifier, the processor starts a timer for the current care session. The timer may be implemented using one or more clocks of the processor, or using a discrete clock.

At 916, the processor determines whether the end user caregiver has selected one of the service type user selectable icons. As previously explained, the service type user selectable icons specify various different types of services which may be provided as part of providing care. Selection of a service type of user selectable icon indicates that reading of a machine-readable symbol will be skipped. As explained above, this will typically occur when away from a defined space associated with the care recipient (e.g., resident, patient) or when a machine-readable symbol is otherwise not available or readable (e.g., damaged or obscured). The provision of two alternatives (i.e., scan selection or service type selection) automatically implements the bifurcated approach discussed above.

At 918, the processor causes a displaying of a space identification user selectable icon. The space identification user selectable icon allows the end user to enter an identifier associated with at least one of a defined space or a care recipient logically associated with the defined space. Such is particularly useful where a machine-readable symbol encoding similar information is not available or readable. In particular, this allows automatic tracking of a caregiving session even when started away from the defined space logically associated with the care recipient. The space identification user selectable icon may, for example, take the form of a scrollable set of room numbers. Such may, for instance, be implemented to appear as a wheel or reel which appears to rotate when swiped or otherwise activated by the end user caregiver. Such may allow scrolling in two opposed directions.

At 920, the processor determines whether a space identifier has been received or selected. If not, a wait loop may be executed by returning to 920. Alternatively, in response to receipt or selection of the space identifier, at 922 the processor may start a timer for current care session. Again, the timer may be implemented via one or more clocks integral to the processor or via some discrete clock.

Whether the space identifier was determined by the reader or was otherwise selected or entered by the end user caregiver, at 924 the processor causes a displaying of a task screen with a plurality of task selection user selectable icons. The task selection user selectable icons specify specific tasks associated with caregiving. Different sets of tasks may be logically associated with respective ones of the types of service (i.e., service types). One or more tasks from one set associated with one type of service may appear in one or more sets associated with other types of service.

At 926, the processor determines whether the end user caregiver has selected a task selection user selectable icon or whether a user selection has been received. In response to selection of a task selection user selectable icon, at 928 the processor stops the timer for the current care session. Stopping the timer allows elapsed time for the current care session to be determined. For example, the processor may determine the start time and the stop time, storing such information. Alternatively or additionally, the processor may determine and store the elapsed time.

In response to selection of a task selection user selectable icon, at 930 the processor also logically associates the selected task with information indicative of elapsed time (e.g., start and stop time and/or determined elapsed time), the defined space (e.g., defined space identifier) and/or end user care provider identity (e.g., end user caregiver name or identifier) for the current care session. The processor may store this information in a data structure, for example a record or entries in one or more tables on appropriate nontransitory processor-readable storage media. Additionally or alternatively, the processor may electronically transmit this information. Such may be performed substantially continuously, during performance of 902-926. Alternatively, such may be performed at or during defined portions of the method 1000.

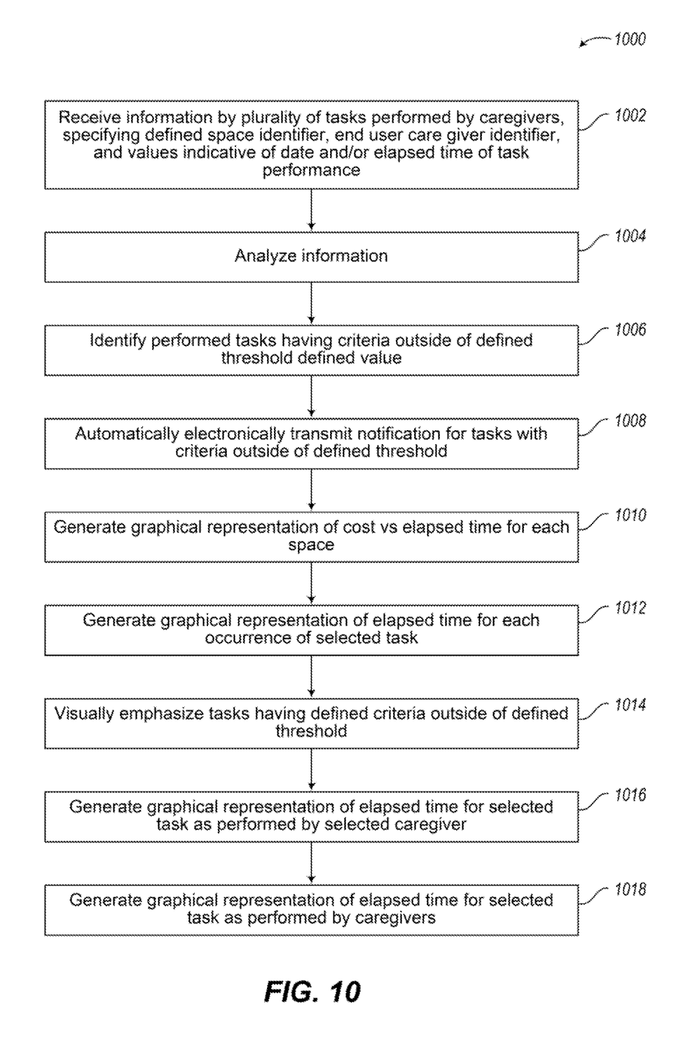

FIG. 10 shows a method 1000 of operation of a caregiving management system, according to one illustrated embodiment.

At 1002, a processor of a caregiving management backend or back office computer system receives information collected by one or more end user caregiver operated handheld caregiving management devices. The received information specifies each of a plurality of tasks performed by a plurality of caregivers. For each task the information specifies a defined space identifier, an end user caregiver identifier, and values indicative of date and/or elapsed time of task performance. The defined space identifier may be logically associable by the processor with a care recipient. For instance, an apartment or room number may be logically associated with a resident or patient who resides in or has been assigned to the particular apartment or room. The end user caregiver identifier may take the form of the caregiver's name or some other identifier such as a number or employee identifier. The date may be provided in any desired format, for example month, day, year, or day, month, year. The information indicative of elapsed time may be the actual amount of elapsed time and/or may be a start time and stop time from which elapsed time may be determined. Where start and stop times are provided, dates associated with the start and stop times should also be provided. This permits correct determination of elapsed time in instances where a caregiving tasks starts one day (e.g., 11:30 PM) and ends the next day (e.g., 12:36 AM).

At 1004, the processor analyzes or otherwise processes the received information. For example, the processor may determine elapsed time based on start and stop times for each task. Other specific examples of analysis are discussed below with reference to FIG. 10.

At 1006, the processor identifies any of the performed tasks which have one or more criteria that fall outside of respective defined thresholds or ranges of a respective defined value.

At 1008, the processor causes the automatic electronic transmission of a notification for tasks with one or more criteria outside of the respective defined threshold. For example, the processor may cause one or more of an electronic mail message (i.e., email), short message service (i.e., SMS) message, facsimile, voicemail, or other electronic message to be sent to a remote device. The processor may also cause an alert or other notification to be produced at the caregiving management backend or back office computer system.

At 1010, the processor generates a graphical representation of fees versus elapsed time for each defined space or care recipient. For example, the processor may cause a graph representing such information to be displayed on a display or monitor, or to print a paper hardcopy of such a graph. Such allows easy assessment of when fees charged are either insufficient to cover the actually provided services or where fees charged exceed the amount of provided services

At 1012, the processor generates a graphical representation of elapsed time for each occurrence of a selected task. Again, the processor may cause a graph representing such information to be displayed on a display or monitor, or to print a paper hardcopy of such a graph. Such allows a comparison of cost recovery on a per task basis. In particularly, this facilitates easy comparisons between tasks.

At 1014, the processor visually emphasizes in the graphical representation any tasks having one or more defined criteria that fall outside of respective defined thresholds of expected values for the criteria. Such may include changing a visual appearance of a marker or indicia associated with one of the criteria. For example, a marker or indicia representing an out-of-range value may be represented in a different color, with highlighting, flashing or marqueeing effects. Such is indicated for a selected space (e.g., apartments in FIG. 7).

At 1016, the processor generates a graphical representation of elapsed time for selected tasks as performed by one or more selected caregivers.

At 1018, the processor generates a graphical representation of elapsed time for selected tasks as performed by caregivers.

Optionally, the at least one processor stores or causes the storage of the response relationship, and data defining the response relationship or information discerned therefrom. For example, the at least one processor may store information in one or more nontransitory storage media collocated with the processor, or may cause the storage of such in one or more nontransitory storage media coupled to store information from a plurality of handheld caregiving management device(s) 112. Such may be performed substantially continuously, during performance of 1002-1018. Alternatively, such may be performed at or during defined portions of the method 1000.

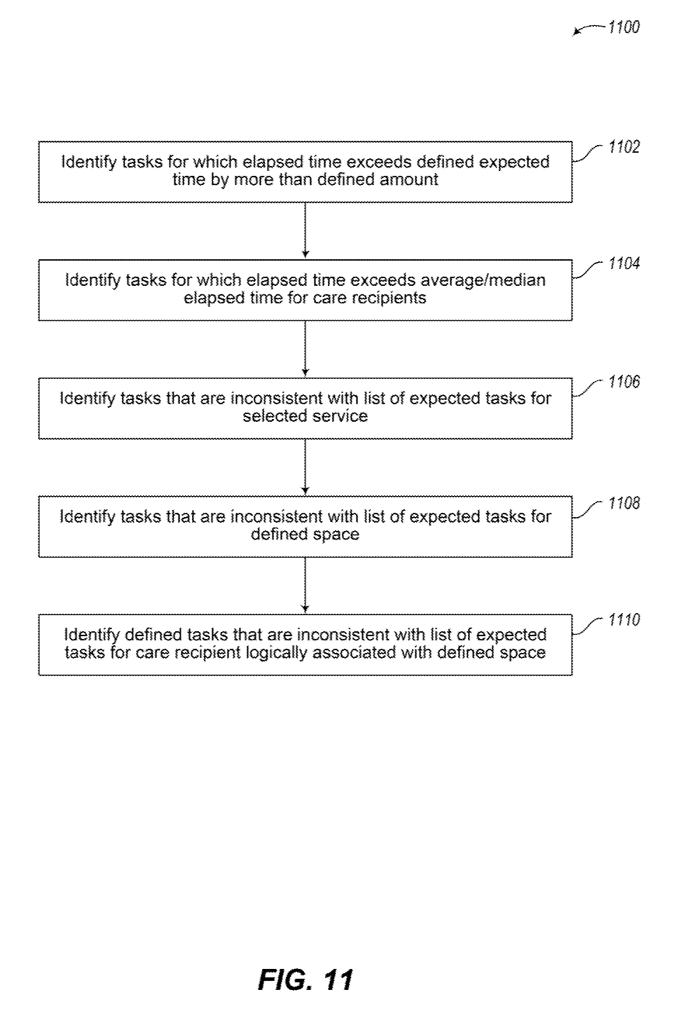

FIG. 11 shows a method 1100 of operation of a caregiving management system, according to one illustrated embodiment.

At 1102, a processor of a caregiving management backend or back office computer system identifies any tasks for which elapsed time exceeds defined expected time by more than a defined amount. For example, specific amounts of expected or acceptable elapsed time may be established for various caregiving tasks. These may be based in part on actual experience, for example across a large population of care recipients, care facilities, and/or population or caregivers. Such may, or may not, be based in part on an ability to recoup costs associated with a given task, for instance an ability to receive reimbursement from a payer, whether private individual, private insurer, or public insurer (e.g., Medicare, Medicaid). The processor may compare actual elapsed times for performance of caregiving tasks to that specified or listed as expected or acceptable for a given caregiving task, identifying or noting any discrepancies. Such may employ a threshold or range around the specified or listed expected or acceptable elapsed times.

At 1104, the processor identifies any tasks for which elapsed time exceeds an average/median elapsed time for a general or specific population of care recipients. For example, the processor may determine either an average or median or both of actual times for performance of one or more caregiving tasks. Such may be specific to a particular caregiving facility or portion thereof (e.g., independent living, assisted living, or skilled nursing units, hospitals, in home care, adult family homes). This approach may readily account for discrepancies which are related to a particular facility or portion thereof. Thus, the system may automatically account for differences in the resident or patient population, or differences in physical infrastructure, or even differences in training and/or compensation of the caregiving personnel. The processor may compare actual elapsed times for performance of caregiving tasks to that specified or listed for a given caregiving task, identifying or noting any discrepancies from an average or median. Such may employ a threshold or range around the average or median.

At 1106, the processor identifies any caregiving tasks that are inconsistent with a list of expected tasks for a selected service. For example, a defined caregiving service may be logically associated with a set (i.e., one or more) or a particular prescribed list of defined caregiving tasks to be performed as part of performing the particular caregiving service. The list of defined caregiving tasks may simply define one or more caregiving tasks to be performed for the particular caregiving service. Such may additionally specify a frequency of performance for one or more of the caregiving tasks. Such may additionally or alternatively set out a specific order in which the caregiving tasks are to be performed as part of the defined service. Such may additionally or alternatively set out specific times at which one or more of the caregiving tasks are to be performed. Such may additionally or alternatively set out specific elapsed times for performing one or more of the specific caregiving tasks on the list. The processor may compare actually performed caregiving tasks, frequency, order, elapsed times, and/or actual times of performance to that specified or listed, identifying or noting any discrepancies including omissions.

At 1108, the processor identifies any caregiving tasks that are inconsistent with a list of expected tasks for a defined space. For example, a defined space may be logically associated with a particular prescribed list of defined caregiving tasks to be performed. The list of defined caregiving tasks may simply define one or more caregiving tasks to be performed for the particular resident or patient. Such may additionally specify a frequency of performance for one or more of the caregiving tasks. Such may additionally or alternatively set out a specific order in which the caregiving tasks are to be performed. Such may additionally or alternatively set out specific times at which one or more of the caregiving task are to be performed. Such may additionally or alternatively set out specific elapsed times for performing one or more of the specific caregiving tasks on the list. The processor may compare actually performed caregiving tasks, frequency, order, elapsed times, and/or actual times of performance to that specified or listed, identifying or noting any discrepancies including omissions.

At 1110, the processor identifies any caregiving tasks that are inconsistent with a list of expected caregiving tasks for a care recipient logically associated with a defined space. For example, a defined space may be logically associated with a particular resident or patient for which a prescribed list of caregiving tasks may be defined. The list of defined caregiving tasks may simply define one or more caregiving tasks to be performed for the particular resident or patient. Such may additionally specify a frequency of performance for one or more of the caregiving tasks. Such may additionally or alternatively set out a specific order in which the caregiving tasks are to be performed. Such may additionally or alternatively set out specific times at which one or more of the caregiving tasks are to be performed. Such may additionally or alternatively set out specific elapsed times for performing one or more of the specific caregiving tasks. The processor may compare actually performed caregiving tasks, frequency, order, elapsed times, and/or actual times of performance to that specified or listed, identifying or noting any discrepancies including omissions.

### CONCLUSIONS

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via microprocessors, Application Specific Integrated Circuits (ASICs), programmable logic controllers (PLCs), or programmable gate arrays (PGAs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Various methods and/or algorithms have been described. Some or all of those methods and/or algorithms may omit some of the described acts or steps, include additional acts or steps, combine acts or steps, and/or may perform some acts or steps in a different order than described. Some of the methods or algorithms may be implemented in software routines. Some of the software routines may be called from other software routines. Software routines may execute sequentially or concurrently, and may employ a multi-threaded approach.

Causing electronic transmission of an alert to a device located remotely from the handheld caregiving management device(s) 112 may, for example, include sending an electronic message (e.g., email message, text message, voicemail message) to a host computer system, an end user computer system, a telephone or Smartphone. The message may optionally identify the specific space or care recipient, caregiver, facility, date and/or time, or even the condition that gave rise to the alert.

In addition, those skilled in the art will appreciate that the mechanisms taught herein are capable of being distributed as a program product in a variety of forms, and that an illustrative embodiment applies equally regardless of the particular type of nontransitory signal bearing media used to actually carry out the distribution. Examples of nontransitory signal bearing media include, but are not limited to, the following: recordable type media such as portable disks and memory, hard disk drives, CD/DVD ROMs, digital tape, computer memory, and other non-transitory computer-readable storage media.

The various embodiments described above can be combined to provide further embodiments.

The information collected, tracked or discerned may allow management of a caregiving facility, for instance a managed care facility or even a hospital. Such may allow identification or separation of variations related to human (e.g., user or operator) performance from variations related to care recipients or facility infrastructure. Such may be particularly useful in targeting remedial actions. Remedial actions may include training of individuals or groups, redesign or reengineering of processes, changing procedures, directives or specifications, or even suppliers or vendors. Remedial action may also include increasing or decreasing fees for services, for example increasing or decreasing a periodic payment for services on a space-by-space or care recipient-by care recipient basis.

The various methods and techniques described above provide a number of ways to carry out the various embodiments. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and acts discussed above, as well as other known equivalents for each such feature or act, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, it is not intended that the invention be limited, except as by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Application No. 61/608,525 filed Mar. 8, 2012 (130246.401P1), and U.S. Provisional Application No. 61/727,547 filed Nov. 16, 2012 (130246.401P2), are incorporated herein by reference, in their entirety. Aspects of the embodiments can be modified, if necessary to employ concepts of the various patents, applications and publications to provide yet further embodiments.

What is claimed is:

1. A mobile device to track care, comprising:
a housing sized to be carried by an end user caregiver;
at least one reader operable to read identifying information proximally associated with respective ones of a plurality of defined spaces which are in turn logically associated with respective ones of a plurality of care recipients;
at least one transceiver operable to provide wireless communications;
a touch-sensitive display operable to display information including a number of user-selectable icons as at least part of a user interface on one or more successive screens presented by the touch-sensitive display;
at least one nontransitory processor-readable medium that stores data and executable instructions which at least in part define at least part of the user interface;
at least one processor communicatively coupled to the at least one reader, the at least one transceiver, the touch-sensitive display, and the at least one nontransitory processor-readable medium to implement as least part of the user interface, the at least one processor configured to:
in response to a first user input, cause the at least one reader to acquire a defined space identifier that uniquely identifies a specific defined space to be logically associated with the delivery of care; and
in response to a second user input, display a space identification user selectable icon which allows the end user caregiver to uniquely specify a specific defined space to be logically associated with the delivery of care by the end user caregiver.

2. The mobile device of claim 1 wherein the at least one processor is further configured to cause a display of a start scan user selectable icon, and in response to a user selection of the start scan user selectable icon cause the at least one reader to acquire information which uniquely identifies a specific defined space to be logically associated with the delivery of care and start a timer for a current care session.

3. The mobile device of claim 2 wherein the at least one processor is further configured to cause display of a plurality of service type user selectable icons, each of the service type user selectable icons which specify a respective type of service provided as part of caregiving, where the second user input is a user selection of one of the service type user selectable icons.

4. The mobile device of claim 3 wherein the at least one processor is configured to cause the display of the start scan user selectable icon selection concurrently on a single screen with the display of the plurality of service type user selectable icons.

5. The mobile device of claim 3 wherein the at least one processor is further configured to, following the start of the timer for the current care session, cause a display of a task screen including a plurality of task selection user selectable icons which specify a respective one of a plurality of tasks provided as part of caregiving for the current care session.

6. The mobile device of claim 5 wherein the at least one processor is further configured to, in response to a user selection of the one of the service type user selectable icons, stop the timer for the current care session and logically associate the respective task with information indicative of at least an elapsed time for the current care session and indicative of the defined space for the current care session.

7. The mobile device of claim 1 wherein in response to the end user caregiver uniquely specifying the specific defined space to be logically associated with the delivery of care for the current care session, the at least one processor is further configured to start the timer for a current care session.

8. The mobile device of claim 7 wherein the at least one processor is further configured to, following the start of the timer, cause a display of a task screen including a plurality of task selection user selectable icons which specify a respective one of a plurality of tasks provided as part of caregiving for the current care session.

9. The mobile device of claim 8 wherein the at least one processor is further configured to, in response to a user selection of the one of the task selection user selectable icons, stop the timer for the current care session and logically associate the respective task with information indicative of at least an elapsed time and indicative of the defined space for the current care session.

10. The mobile device of claim 1 wherein the at least one processor is configured to display the space identification user selectable icon as a scrollable set of room numbers.

11. The mobile device of claim 1 wherein the at least one reader is a machine-readable symbol reader operable to read machine-readable symbols located proximate an access way to the defined space.

12. The mobile device of claim 1 wherein the at least one reader is a machine-readable symbol reader operable to read machine-readable symbols located proximate a doorway of the defined space.

13. The mobile device of claim 1 is has a machine-readable symbol reader scanner removably coupled to the housing thereof.

14. A method of operating a mobile device to track care, the mobile device comprising at least one reader, at least one transceiver, a touch-sensitive display, at least one nontransitory processor-readable medium that stores data and executable instructions which at least in part define at least part of the user interface, and at least one processor communicatively coupled to the at least one transceiver and the at least one nontransitory processor-readable medium, the method comprising:
causing by the at least one processor a displaying of a start scan user selectable icon by the touch-sensitive display; and
causing by the at least one processor a displaying of a plurality of service type user selectable icons by the touch sensitive display, each of the service type user selectable icons which specify a respective type of service provided as part of caregiving;
in response to a user input by an end user caregiver indicative of a selection of one of the service type user selectable icons, causing by the at least one processor a displaying of a space identification user selectable icon on the touch-sensitive display, selection of the space identification user selectable icon which allows the end user caregiver to uniquely specify a specific defined space to be logically associated with the delivery of care for a current care session.

15. The method of claim 14, further comprising:
in response to a user input by the end user caregiver indicative of a selection of the start scan user selectable icon, causing the at least one reader to acquire information which uniquely identifies a specific defined space to be logically associated with the delivery of care and starting a timer for the current care session.

16. The method of claim 15 wherein causing the at least one reader to acquire information which uniquely identifies a specific defined space includes causing at least one of a scanning or an imaging at least one machine-readable symbol at least proximate an access way to the defined space by the reader.

17. The method of claim 16 wherein causing a displaying of a start scan user selectable icon by the touch-sensitive display and causing a displaying of a plurality of service type user selectable icons by the touch sensitive display includes causing the displaying of the start scan user selectable icon selection concurrently on a single screen presented by the touch-sensitive display with the displaying of the plurality of service type user selectable icons.

18. The method of claim 15, further comprising:
following the starting of the timer for the current care session, causing a displaying of a task screen by the touch-sensitive display, the task screen including a plurality of task selection user selectable icons which specify a respective one of a plurality of tasks provided as part of caregiving for the current care session.

19. The method of claim 18, further comprising:
receiving a user input indicative of a selection of the one of the task selection user selectable icons; and
in response to the received user input indicative of the selection of one of the task selection user selectable icons, stopping the timer for the current care session and logically associating the respective selected task for the current care session with information indicative of at least an elapsed time for the current care session and indicative of the defined space for the current care session.

20. The method of claim 14, further comprising:
receiving a user input uniquely specifying the specific defined space to be logically associated with the delivery of care by the end user caregiver for the current care session; and
in response to the received user input uniquely specifying the specific defined space to be logically associated with the delivery of care, starting a timer for the current care session.

21. The method of claim 20, further comprising:
following the starting of the timer for the current care session, causing a display of a task screen including a plurality of task selection user selectable icons which specify a respective one of a plurality of tasks provided as part of caregiving.

22. The method of claim 21, further comprising:
receiving a user input indicative of a selection of the one of the task selection user selectable icons for the current care session;
in response to the received user input indicative of the selection of one of the task selection user selectable icons, stopping the timer for the current care session and logically associating the respective selected task for the current care session with information indicative of at least an elapsed time for the current care session and indicative of the defined space for the current care session.

23. The method of claim 21, further comprising:
receiving a user input indicative of an identity of the end user caregiver providing care for the current care session;
receiving a user input indicative of a selection of the one of the task selection user selectable icons for the current care session;
in response to the received user input indicative of the selection of one of the task selection user selectable icons, stopping the timer for the current care session and logically associating the respective selected task for the current care session with information indicative of at least an elapsed time for the current care session, indicative of the defined space for the current care session, and indicative of the identity of the caregiver providing care for the current care session.

24. The method of claim 14 wherein causing a displaying of a space identification user selectable icon on the touch-sensitive display includes causing the displaying of the space identification user selectable icon as a scrollable set of room numbers.

25. A method of operating a caregiving tracking system, the method comprising:
receiving information by the caregiving tracking system for each of a plurality of tasks performed by each of a number of caregivers, the information specifying for each of the tasks a defined space identifier associated with where the respective task was performed, and at least one value indicative of a date on which the respective task was performed and indicative at least of an elapsed time during which the respective task was performed;
from time to time, analyzing the information; and
identifying any of the performed tasks having defined criteria which are outside of a defined threshold of a defined value.

26. The method of claim 25, further comprising:
automatically electronically transmitting a notification for any defined task having defined criteria which are outside of a defined threshold of a defined value.

27. The method of claim 25 wherein identifying any of the performed tasks having defined criteria which are outside of a defined threshold of a defined value includes identifying any defined tasks for which an elapsed time exceeds a defined expected time by more than a defined amount.

28. The method of claim 25 wherein identifying any of the performed tasks having defined criteria which are outside of a defined threshold of a defined value includes identifying any defined tasks for which an elapsed time exceeds at least one of an average or a median elapsed time for the respective task over a population of care recipients.

29. The method of claim 25 wherein identifying any of the performed tasks having defined criteria which are outside of a defined threshold of a defined value includes identifying any defined tasks that are inconsistent with a list of expected tasks for a selected service.

30. The method of claim 25 wherein identifying any of the performed tasks having defined criteria which are outside of a defined threshold of a defined value includes identifying any defined tasks that are inconsistent with a list of expected tasks for a respective defined space.

31. The method of claim 25 wherein identifying any of the performed tasks having defined criteria which are outside of a defined threshold of a defined value includes identifying any defined tasks that are inconsistent with a list of expected tasks for a care recipient logically associated with a respective defined space.

32. The method of claim 25, further comprising:
generating a graphical representation of a respective elapsed time for each occurrence of at least one selected task.

33. The method of claim 32, further comprising:
visually emphasizing in the graphical representation any tasks having defined criteria which are outside of a defined threshold of a defined value.

34. The method of claim 25, further comprising:
generating a graphical representation of a respective elapsed time for each occurrence of at least one selected task as performed by a selected end user caregiver.

35. The method of claim 25, further comprising:
generating a graphical representation of a respective elapsed time for each occurrence of at least one selected task as performed by a population of end user caregivers.

36. The method of claim 25 wherein the information further specifying for each of the tasks an identifier indicative of an end user caregiver that performed the respective task.

37. A method of operating a caregiving tracking system including at least one hand operated mobile device having at least one processor and a user interface, the method comprising:
for example of a number of residents of an assisted living facility,
starting a timer implemented on the hand operated mobile device at a start of providing of a service to a respective one of the residents,
identifying the respective one of the residents to whom the service is being provided on the hand operated mobile device,
identifying the service being provided to the respective one of the residents on the hand operated mobile device, and
collecting information specifying the resident, the time devoted to providing at least one service and the type of service to at least one non-transitory storage medium; and
from time-to-time,
determining for a given period whether actual time devoted to providing at least one service is within at least range of a defined time allocated for providing the at least one service based on the collected information.

38. The method of claim 37 wherein for at least one of the residents starting a timer includes: in response to a selection of a read icon of the user interface of the hand operated mobile device, reading an identifier by a reader of the hand operated mobile devices, the identifier positioned at least proximate a residence of the respective one of the residents.

39. The method of claim 37 wherein for at least one of the residents identifying the respective one of the residents to whom the service is being provided includes: receiving at least one selection of at least one user selectable icon displayed as part of the user interface of the hand operated mobile device, the at least one user selectable icon logically associated with the respective one of the residents.

40. The method of claim 37 wherein for at least one of the residents identifying the service being provided to the respective one of the residents includes: receiving at least one selection of at least one user selectable icon displayed as part of the user interface of the hand operated mobile device, the at least one user selectable icon logically associated with the respective service.

41. The method of claim 37 wherein for at least one of the residents starting a timer implemented on the hand operated mobile device at a start of providing of a service to a respective one of the residents includes: receiving at least one selection of at least one user selectable icon displayed as part of the user interface of the hand operated mobile device, the at least one user selectable icon logically associated with the respective service.

42. The method of claim 37 wherein for at least one of the residents starting a timer implemented on the hand operated mobile device at a start of providing of a service to a respective one of the residents includes: receiving at least one selection of at least one user selectable icon displayed as part of the user interface of the hand operated mobile device, the at least one user selectable icon logically associated with a timer function implemented on the hand operated mobile device.

43. The method of claim 37 wherein determining for a given period whether actual time devoted to providing at least one service is within at least a range of a defined time allocated for providing the at least one service includes: comparing actual time devoted to providing at least one service to a respective one of the residents to actual time devoted to providing the at least one service to a plurality of the residents.

44. The method of claim 37 wherein determining for a given period whether actual time devoted to providing at least one service is within at least a range of a defined time allocated for providing the at least one service includes: identifying any any services for which an elapsed time exceeds at least one of an average or a median elapsed time for the respective service over a population of care recipients.
